(19) United States
(12) Patent Application Publication
(10) Pub. No.: US 2023/0003055 A1
(43) Pub. Date: Jan. 5, 2023

(54) LOCK DEVICE AND LOCKING HASPS THEREOF

(71) Applicant: ONE LUS INTERNATIONAL CO., LTD., Kaohsiung City (TW)

(72) Inventor: Ping-Hua WU, Kaohsiung City (TW)

(21) Appl. No.: 17/732,545

(22) Filed: Apr. 29, 2022

(30) Foreign Application Priority Data
Jul. 1, 2021 (TW) 110124216

(51) Int. Cl. E05B 67/38; E05B 67/06

(52) U.S. Cl. CPC E05B 67/38; E05B 67/06

(57) ABSTRACT

A lock device includes a lock body that includes a bottom portion and a top portion. The lock body is formed, in the interior thereof, with a first accommodation zone, a second accommodation zone, a lock bore, a protective cover lid, a lock core, and a closure plate. The lock device includes a shackle that is deeply hidden inside the lock body and is thus protected from being damaged. A lock core is disposed into the lock body from the bottom portion, so that the lock core is arranged, in an upstanding manner, inside the lock body, and a keyhole of the lock core faces the top portion of the lock body to allow the keyhole to be readily found for conducting an unlocking operation. The lock core is protected by a protective cover lid from being easily destructed.

### TECHNICAL FIELD OF THE INVENTION

The present invention relates generally to a lock device and locking hasps thereof, and more particularly to a lock device and locking hasps thereof that hide a shackle and are easily applicable to locking of vehicle compartments and large-sized warehouse doors.

### DESCRIPTION OF THE PRIOR ART

Mechanical locks have been long favored by people, and mechanical locks implemented in the form of padlocks are the most favorite ones because of easy operation. Locking of a padlock is conducted through operating a shackle. However, conventionally, the shackle is exposed outside the lock and destruction may be made to the exposed shackle, or connection between the shackle and the lock body, by an evildoer. Thus, the shackle is commonly considered a fatal weakness of the lock device.

Recent development brought a lock device that conceals the shackle, such as one shown in FIGS. 1 and 2, in which a lock device comprises a lock body 1 and a shackle 2, as well as locking hasps 3 that are used in combination with the lock device. To use, fasteners are applied to first fix the locking hasps 3 to an object that is to be locked with the lock device. The lock body 1 is subjected to special treatment of metal to exhibit a high strength, so that the lock body 1 is strong enough to resist knocking and drilling applied with an external force thereto. When locked, the shackle 2 is covered by and hidden in the lock body so as not be exposed outside. In this way, the shackle 2 is protected from being destructed by an externally applied force. To use, the shackle 2 of the lock device penetrate through two locking hasps to achieve locking thereby completing the locking operation of the lock device.

Such as known lock device allows the shackle 2 to be covered by and hidden in the lock body 1 and also provides the lock body 1 with a high strength for resisting destruction through application of external forces, so as to achieve a high level of protection and be favored by people. In many regions, people are used to applying such a lock device 1 to lock a compartment of a large-sized vehicle, and there are also people who prefers for applications to locking of doors or large-sized warehouses.

However, a lock tongue (not shown) arranged at an end of a lock core 11 of the known lock device is connected to an end of the shackle 2 to combine the lock core 11 and shackle 2 together in a coaxial arrangement, so that the shackle 2 is drivable to rotate by the lock core 11. Further, tumblers 12 are arranged alongside the lock core 11. To provide the lock core 11 with an increased length for accommodating a larger number of tumblers 12 to thereby achieve high variability of arrangement of the tumblers 12 for being not easily broken, the known lock body 1 of such a design is commonly of a large diameter. Further, a keyhole of the lock core 11 of such a known lock device is commonly formed in a side of the lock body 1. Practically, the keyhole is very close to the locking hasps 3 and as such, operations of inserting, rotating, and withdrawing a key for locking and unlocking are easily interfered with, leading to inconvenience for practical uses thereof.

### SUMMARY OF THE INVENTION

The present invention generally relates to a lock device and locking hasps thereof, which are mainly made for overcoming or alleviating the drawbacks of the prior art lock device that is bulky and is hard to operate with a key.

For such a purpose, the present invention provides a lock device and locking hasps thereof. The lock device according to the present invention comprises, at least, a lock body and a shackle, wherein the lock body includes a bottom portion and a top portion, and the lock body is formed or provided, in the interior thereof, with a first accommodation zone, a second accommodation zone, a lock bore, a protective cover lid, a lock core, and a closure plate. The bottom portion is located on a bottom side of the lock body and is formed with a recessed area that is slightly recessed inwardly into the interior of the lock body. The top portion is located on a top side of the lock body and is formed with a hole. The first accommodation zone is made in the form of a cylindrical hole. The first accommodation zone is formed through recessing from an interior portion of the recessed area of the bottom portion further into the interior of the lock body to be in communication with the hole of the top portion. The second accommodation zone is formed through recessing the bottom portion inwardly of the lock body. The second accommodation zone includes a communication section that is in communication with the first accommodation zone. The lock bore perpendicularly extends from a lateral side of the lock body into, and is in communication with, the second accommodation zone, and the lock bore is set in communication with one side of the first accommodation zone. The protective cover lid is in the form of a circular plate that is made of a metallic material that has been subjected to heat treatment to exhibit a high strength and is received in the first accommodation zone. The protective cover lid is formed therein with a penetration opening that penetrates through a main body thereof. The lock core has one end that is provided with a lock tongue and an opposite end that is formed with a keyhole. The lock tongue is extendible out of a lateral side surface of the lock core. The end of the lock core that is provided with the lock tongue is further formed with a cut-off notch. The closure plate is formed to has a contour that corresponds to and matches with the recessed area of the bottom portion. The closure plate includes an inset portion extended from one surface thereof to match with the communication section of the second accommodation zone. The shackle is made in the form of a cylindrical rod made of a metallic material that has been subjected to heat treatment to exhibit a high strength. The shackle comprises a shackle body and a rounded end portion, and an end of the shackle body that is opposite to the rounded end portion is formed as a hook portion. The shackle is sleeved with a spring.

The efficacy that the above-described structure of the present invention may provide is that in the present invention, the shackle can be deeply hidden in the lock body and is not readily damaged. The lock core is disposed into the first accommodation zone through the bottom portion of the lock body, so that the lock core is arranged in an upstanding manner in the lock body, and the keyhole faces the top portion of the lock body to allow an operator to easily and efficiently find the keyhole of the lock core for conducting an unlocking operation. Further, the lock core is protected by the protective cover lid from being damaged. Further, since the lock core is arranged in an upstanding manner in the lock body, the diameter of the lock body can be reduced for fabrication and applications so as to achieve compactness and easiness of operation. Further, since the lock core is arranged in an upstanding manner in the lock body, a slight increase of the height of the lock body allows for an increase of the length of the lock core disposed therein, so as to enable increase and sophistication of the tumblers arranged inside the lock core to thereby further increase the difficulty of breaking the lock core, and this further enhances the locking security of the lock device.

### BRIEF DESCRIPTION OF THE DRAWINGS

FIGS. 1 and 2 are schematic views showing a prior art lock device.

FIG. 3 is an exploded view of the present invention.

FIG. 4 is a perspective view, partly broken, showing a lock body of the present invention.

FIG. 5 is a perspective view showing a lock core and a closure plate of the present invention.

FIGS. 6 and 7 are assembled views, in sectioned form, showing the present invention.

FIGS. 8-12 are schematic views showing implementation of the present invention.

FIG. 13 is a schematic view illustrating unlocking of the present invention.

FIGS. 14-17 are schematic views showing another embodiment of the present invention.

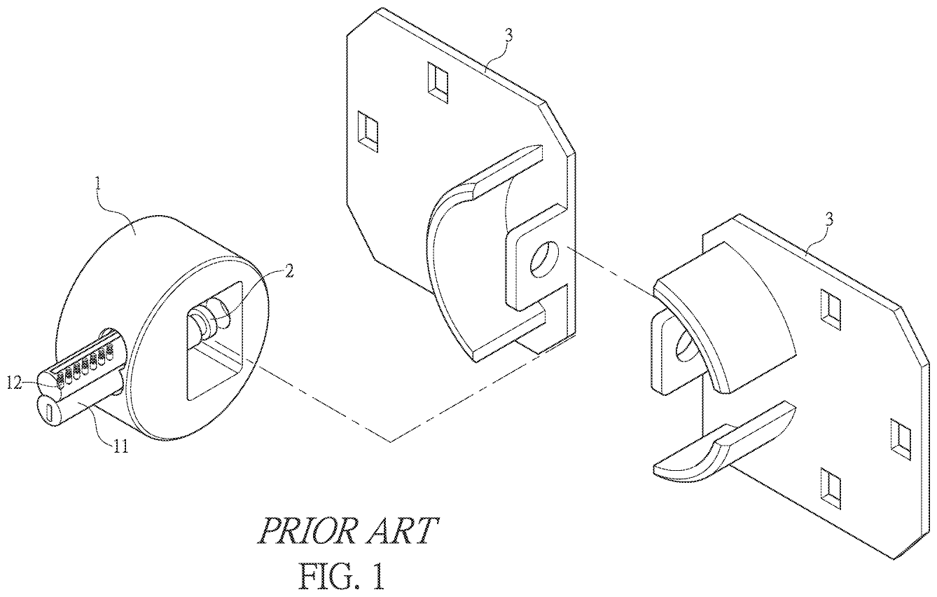

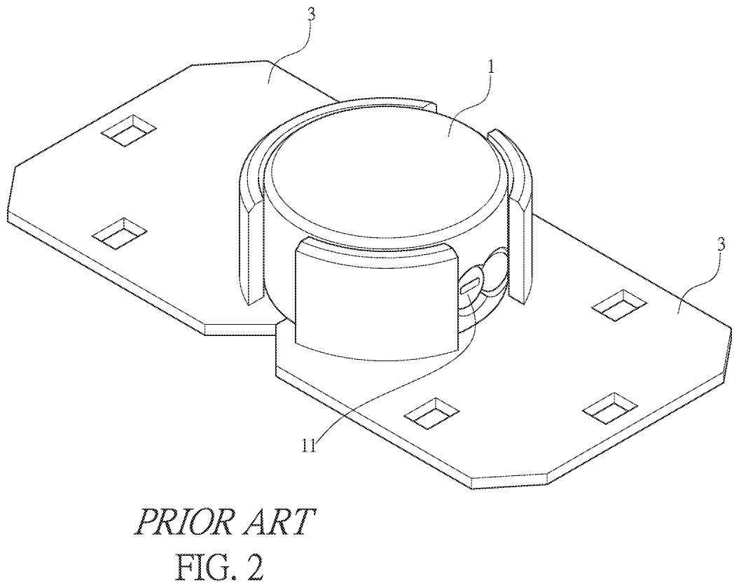

### DETAILED DESCRIPTION OF THE PREFERRED EMBODIMENT

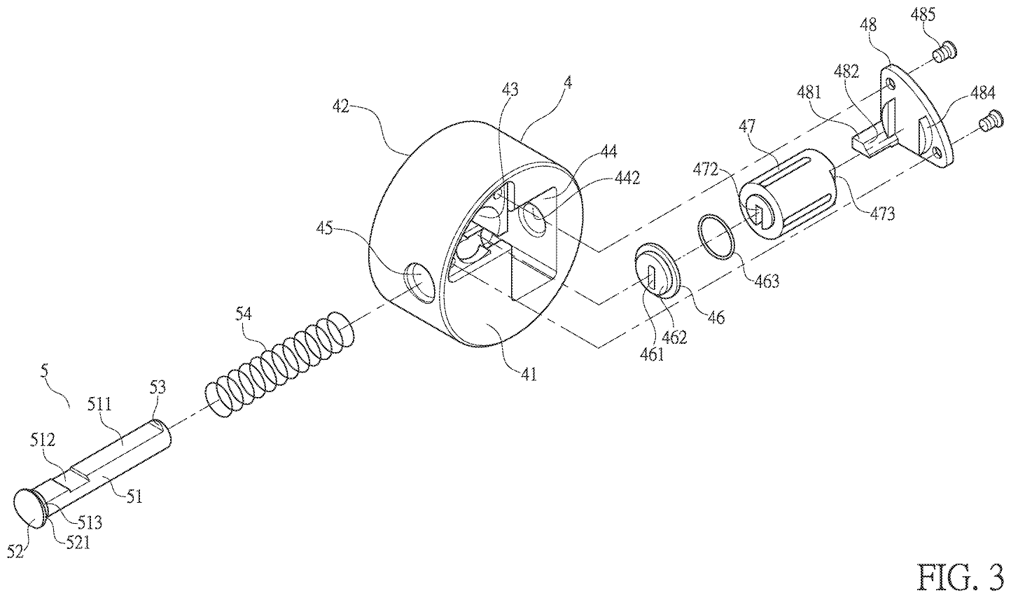

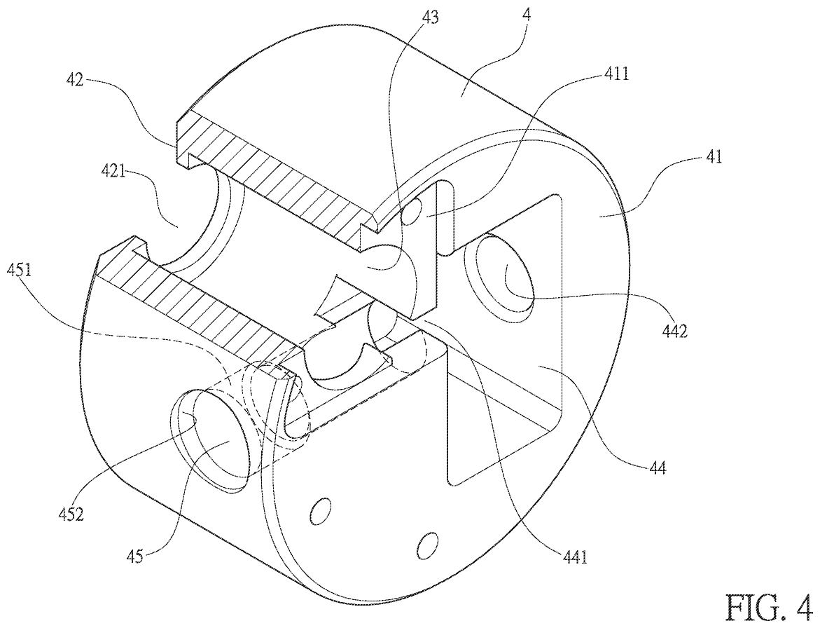

Firstly, with reference to FIGS. 3, 4, and 5, the present invention provides a lock device which comprises, at least, a lock body 4 and a shackle 5.

In the lock device, the lock body 4 is formed as a cylindrical body that is made of a metallic material that has been subjected to heat treatment to exhibit a high strength. The lock body 4 includes a bottom portion 41 and a top portion 42. The lock body 4 includes, as being formed or arranged therein, a first accommodation zone 43, a second accommodation zone 44, a lock bore 45, a protective cover lid 46, a lock core 47, and a closure plate 48.

The bottom portion 41 is arranged at a bottom side of the lock body 4 and is formed with a recessed area 411, which is recessed into interior of the lock body 4.

The top portion 42 is arranged at a top side of the lock body 4 and is formed with a hole 421.

The first accommodation zone 43 is made in the form of a cylindrical hole. The first accommodation zone 43 is formed through recessing from an interior portion of the recessed area 411 of the bottom portion 41 further into the interior of the lock body 4 to be in communication with the hole 421 of the top portion 42. The first accommodation zone 43 has a hole diameter that is greater than a hole diameter of the hole 421 of the top portion 42.

The second accommodation zone 44 is formed through recessing a portion of the bottom portion 41 into the interior of the lock body 4. The second accommodation zone 44 includes a communication section 441 that is in communication with the first accommodation zone 43. The second accommodation zone 44 is also formed, in a sidewall thereof, with a trough 442.

The lock bore 45 perpendicularly extends from a lateral side of the lock body 4 into, and is in communication with, the second accommodation zone 44. Further, the lock bore 45 is arranged to correspond to the trough 442 that is formed in the sidewall of the second accommodation zone 44. Further, the lock bore 45 is made in communication with a side of the first accommodation zone 43. The lock bore 45 includes a large-diameter section 451 that has a relatively large hole diameter adjacent to an outer circumference of the lock body 4. The large-diameter section 451 is provided with an expanded opening section 452 that is inclined so as to extend to and connect to the outer circumference of the lock body 4.

The protective cover lid 46 is in the form of a circular plate that is made of a metallic material that has been subjected to heat treatment to exhibit a high strength. The protective cover lid 46 includes, as being formed therein, a penetration opening 461 that penetrates through a main body thereof. The protective cover lid 46 is formed, on one of surfaces thereof, with a protrusion portion 462 that has a relatively small diameter.

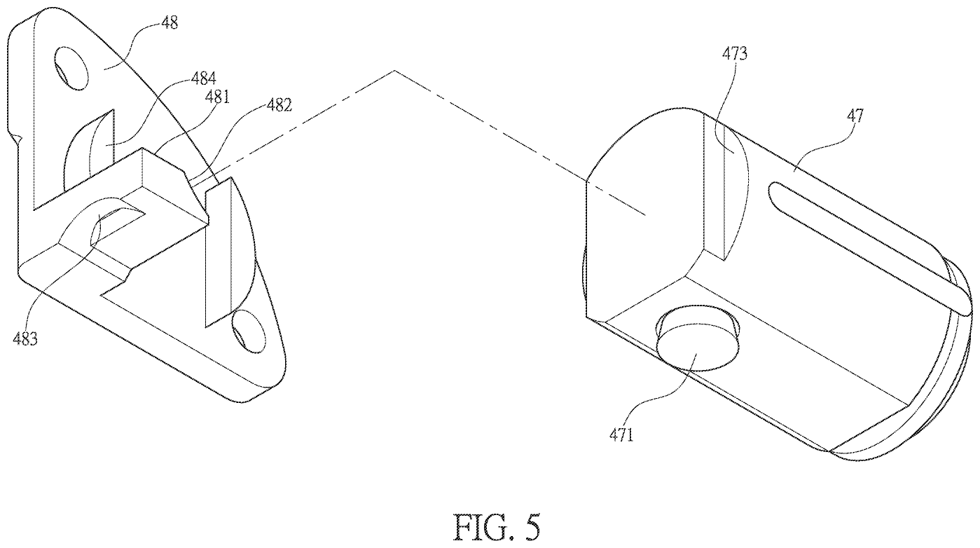

Referring to FIG. 5, the lock core 47 has an outside diameter that corresponds to the hole diameter of the first accommodation zone 43. The lock core 47 is provided, at an end thereof, with a lock tongue 471 and is formed, in an opposite end thereof, with a keyhole 472. The lock tongue 471 is extendible out of a lateral side surface of the lock core 47. Further, the end of the lock core 47 that is provided with the lock tongue 471 is further formed with a cut-off notch 473.

The closure plate 48 is made in a form having a contour matching and in collaborative engagement with the recessed area 411 of the bottom portion 41, and is provided, as being protruded from one of surfaces thereof, with an inset portion 481 that matches with the communication section 441 of the second accommodation zone 44. The inset portion 481 is provided, on a side surface thereof, with an arc-surface side 482 that is in the form of an arc curved surface extending in an axial direction thereof. The inset portion 481 is provided, in an opposite side thereof, with a curved trough 483 in the form of a circular arc configuration. The closure plate 48 further includes a top support portion 484 that is protruded to match with the cut-off notch 473 of the lock core 47.

The shackle 5 is made in the form of a cylindrical rod made of a metallic material that has been subjected to heat treatment to exhibit a high strength. The shackle 5 includes a shackle body 51, and the shackle body 51 has an end that is formed as a rounded end portion 52. The shackle body 51 is provided, on one side thereof, with a flat cut section 511 that extends in an axial direction thereof and includes a surface in the form of a flat plate. The flat cut section 511 is formed therein with a cut-off notch 512. The flat cut section 511 is extended to an end that is opposite to the rounded end portion 52 and does not extend through the end of the shackle body 51, so that the end that is opposite to the rounded end portion 52 is formed as a hook portion 53. A circumferential recessed groove 513 is formed in connection between the shackle body 51 and the rounded end portion 52. A spring 54 is fit over and encompasses the shackle 5. The rounded end portion 52 has an outer surface that is configured to match a shape of the lateral side of the lock body 4. The rounded end portion 52 has an inner surface that is formed as a conic portion 521 converging inwardly, from a large size to a small size, for connection with the shackle body 51.

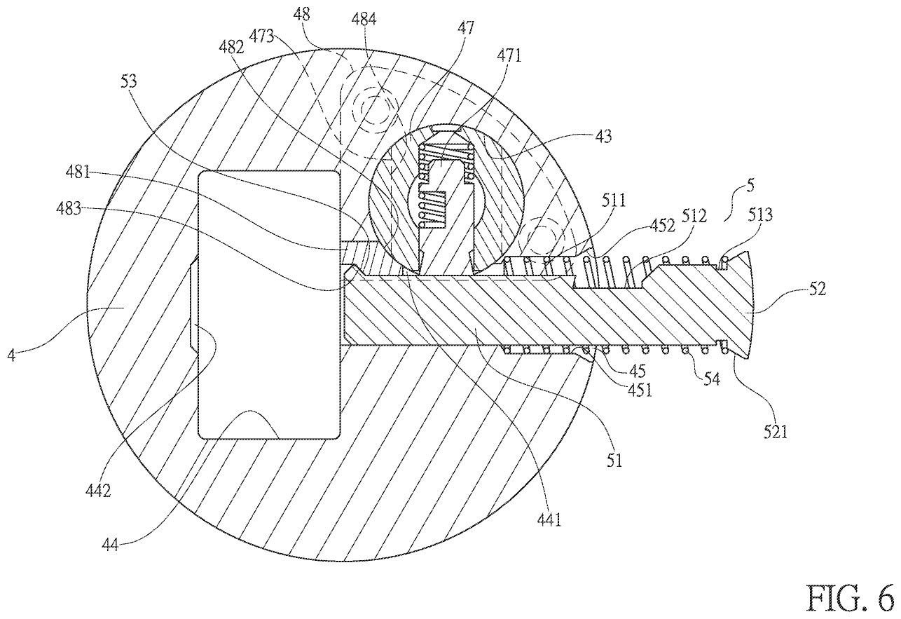

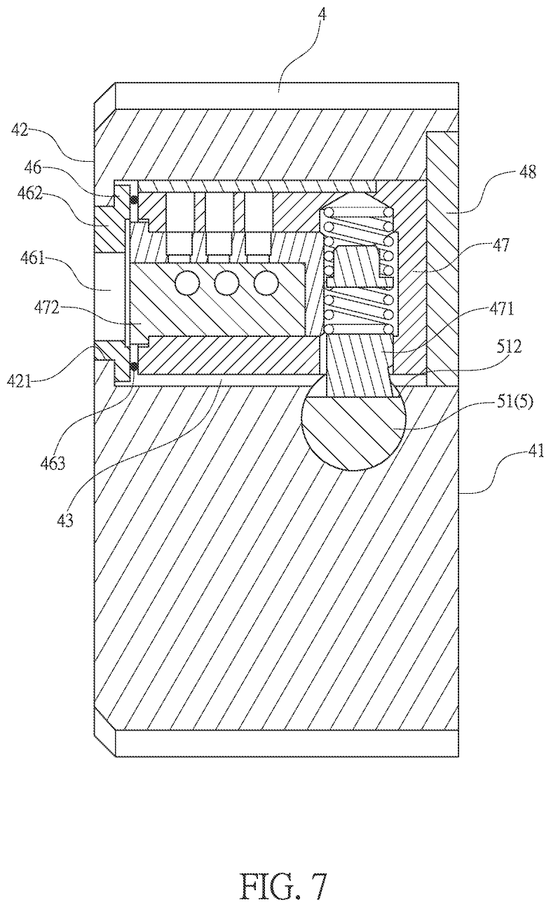

To assemble the invention, reference is made to FIGS. 3-7, in which the protective cover lid 46 is first positioned, by way of the bottom portion 41 of the lock body 4, into the first accommodation zone 43. The protective cover lid 46 has a diameter that is smaller than the hole diameter of the first accommodation zone 43 and larger than the hole 421 of the top portion 42, and the diameter of the protrusion portion 462 of the protective cover lid 46 is smaller than the hole 421 of the top portion 42, so that when the protective cover lid 46 is disposed into the first accommodation zone 43, the protective cover lid 46 is constrained by the hole 421 of the top portion 42 from falling outward. Further, the protrusion portion 462 of the protective cover lid 46 is exactly fit into the hole 421 of the top portion 42, and preferably, the protrusion portion 462 of the protective cover lid 46 is made not higher than a height of the bottom portion 41 of the lock body 4.

Next, the lock core 47 is disposed through the bottom portion 41 of the lock body 4 into the first accommodation zone 43, such that the end of the lock core 47 that is formed with the keyhole 472 is set in a direction of facing the top portion 42 of the lock body 4. As such, the lock core 47 is disposed in an upstanding manner, in the interior of the lock body 4, and the lock core 47 abuts the protective cover lid 46. Preferably, a cushion ring 463 is additionally arranged between the protective cover lid 46 and the lock core 47. In an embodiment, the cushion ring 463 has a cross-section that is preferably circular. By means of the arrangement of the cushion ring 463, a contact area between the lock core 47 and the protective cover lid 46 is reduced to thereby reduce a frictional force between the lock core 47 and the protective cover lid 46. Further, since the lock bore 45 is made in communication with one side of the first accommodation zone 43, the lock tongue 471 of the lock core 47 disposed in the first accommodation zone 43 is extendible into the lock bore 45.

Next, the spring 54 is first sleeved over the shackle 5, and the spring 54 is partly received into and retained in position by the circumferential recessed groove 513 of the shackle 5. The end of the shackle 5 that is formed with the hook portion 53 is arranged to face the lock bore 45 for insertion into the lock body 4, so as to set the flat cut section 511 of the shackle 5 in a direction of facing the lock core 47 disposed inside the lock body 4. Under such a condition, due to the lock tongue 471 of the lock core 47 being extended into and reaching into the lock bore 45, the flat cut section 511 of the shackle 5 is set in abutting engagement with the lock tongue 471 of the lock core 47. Afterwards, the closure plate 48 is mounted by screws 485 to and closes the recessed area 411 of the bottom portion 41 of the lock body 4. Under such a condition, the inset portion 481 of the closure plate 48 is inserted into a portion of the communication section 441 that provides communication between the second accommodation zone 44 and the first accommodation zone 43, so that the arc-surface side 482 of the inset portion 481 is in contact engagement with the lock core 47 that is located in the first accommodation zone 44 to fix the lock core 47. One surface of the inset portion 481 is set flush with a wall of the second accommodation zone 44, and the curved trough 483 of the inset portion 481 is set corresponding to the lock bore 45, so as to have the hook portion 53 of the shackle 5 constrained by the curved trough 483, and the top support portion 484 of the closure plate 48 engage and hold the cut-off notch 473 of the lock core 47 thereby realizing an effect of securely fixing and positioning the lock core 47. This completes the assembly of the lock body 4. Further, in implementation, the closure plate 48 has a thickness that corresponds to the recessed area 411 of the bottom portion 41, so that the closure plate 48, when disposed in and covering the recessed area 411 of the bottom portion 41 of the lock body 4, exhibits a flat form with respect to the bottom portion 41 of the lock body 4.

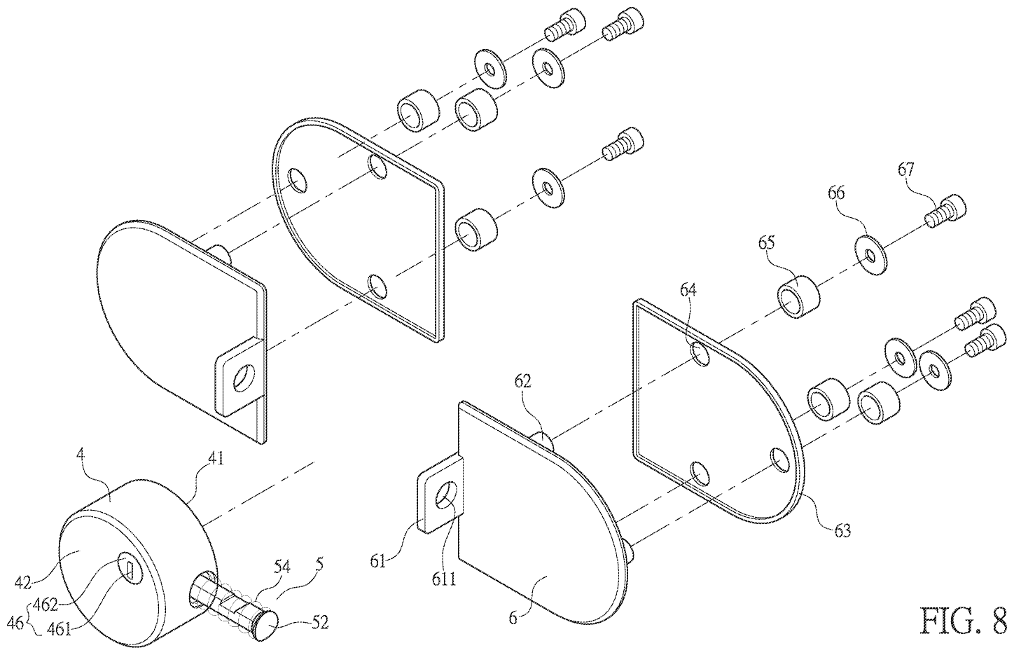

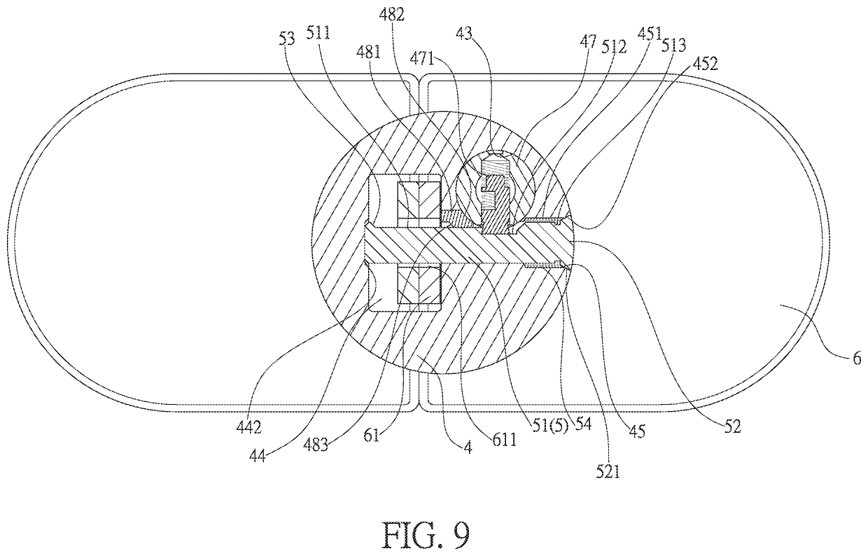

To use the present invention, reference being had to FIGS. 8 and 9, firstly, two locking hasps 6 are separately mounted to an object 7 to which the lock device is to be applied. In implementation, the two locking hasps 6 are made of metallic materials that have been subjected to heat treatment to exhibit high strengths. The locking hasps 6 are provided, at an end of a back side thereof, with a lug 61. The lug 61 is formed with a hole 611. The locking hasps 6 are provided, on a back side thereof, with a plurality of threaded tubes 62 that are provide, in an interior thereof, with a thread. Further, the locking hasps 6 are each fit to a pad 63. The pad 63 includes a plurality of through apertures 64 into which the threaded tubes 62 of the locking hasp 6 are respectively inserted. To implement, the object 7 to which the invention is applied is first formed with holes 71 at locations corresponding to the threaded tubes 62 of the locking hasps 6, and then, the threaded tubes 62 of the hasps 3 are first inserted through the through apertures 64 of the pad 63 to then penetrate from outside of the object 7 into the holes 71. Under this condition, the threaded tubes 62 of the hasps 3 penetrates into the object 7 to reach into the interior thereof, and then, the sleeves 65 are put outside the threaded tubes 62 of the locking hasps 6, and washers 66 are set on the sleeves 65, and finally, bolts 67 are applied to fasten to the threaded tubes 62 of the locking hasps 6, to thereby mount the locking hasps 6 to the object 7 to which the invention is to be applied. Under this condition, the object 7 to which the invention is to be applied shows, from the outside, only the locking hasps 6, while the threaded tubes 62 and the bolts 67 of the locking hasps 6 are completely invisible from the outside, for being totally different from the prior art lock device where the hasps allow the bolts for fastening to get exposed, and therefore demonstrating a high quality of a product according to the invention. Further, the pad 63 functions to block invasion of rainwater and the likes into a space between the locking hasps 6 and the object 7 to prevent rusting from occurring at such a location.

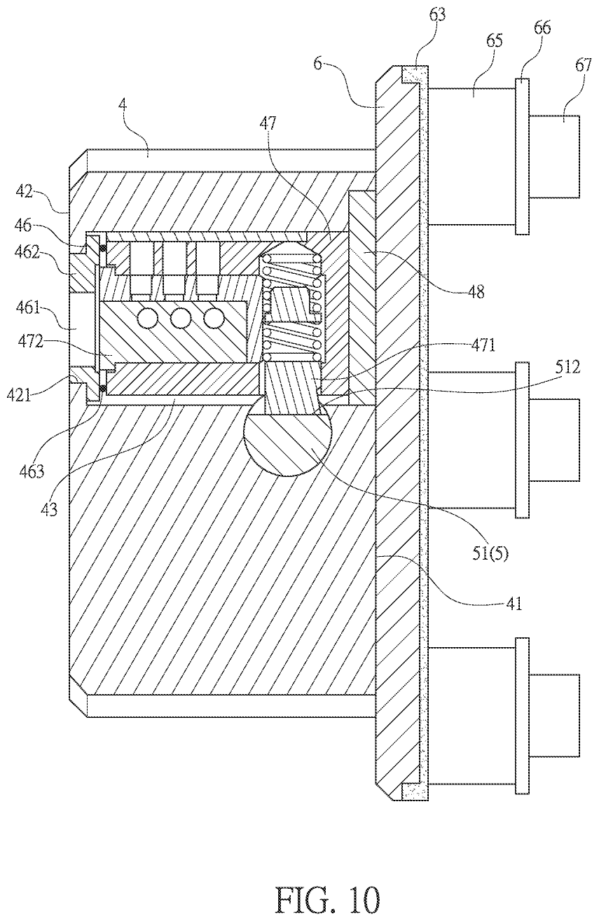

Further referring to FIGS. 8-12, the two locking hasps 6 on the object 7 are moved and positioned so that the two lugs 61 of the two locking hasps 6 correspond to and in alignment with each other in a horizontal direction to make the holes 611 of the two lug 61 corresponding to and in communication with each other. Next, the bottom portion 41 of the lock body 4 is disposed on and houses the two lug 61, so that the second accommodation zone 44 of the lock body 4 encloses and conceals the two lugs 61 in the interior thereof and the top portion 42 of the lock body 4 is made facing outward. Next, pressing is applied to the rounded end portion 52 to press the shackle 5 in a direction toward the interior of the lock body 4. Under such a condition, the shackle 5 moves along the lock bore 45 to reach into the second accommodation zone 44 and penetrating through the holes 611 of the two lug 61, until the lock tongue 471 of the lock core 47 is moved into the cut-off notch 512 of the flat cut section 511 of the shackle 5, and meanwhile, the end of the shackle 5 that is provided with the hook portion 53 gets into abutting engagement with the trough 442 of the second accommodation zone 44, whereby the shackle 5 is thus constrained by the lock tongue 471 of the lock core 47 to complete the operation of locking. Under such a condition, the spring 54 encompassing the shackle 5 is compressed to retract into the large-diameter section 451 of the lock bore 45, and the conic portion 521 of the rounded end portion 52 matches up with the expanded opening section 452 of the lock bore 45 to achieve a mutual abutting engagement therebetween, while the rounded end portion 52 of the shackle 5 is set in flush with the outer circumference of the lock body 4.

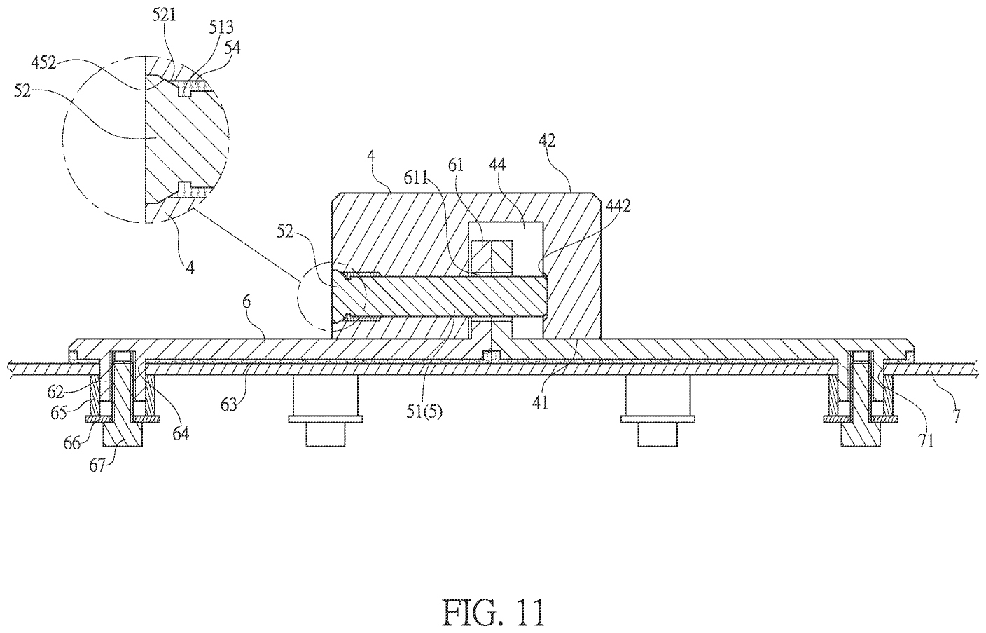

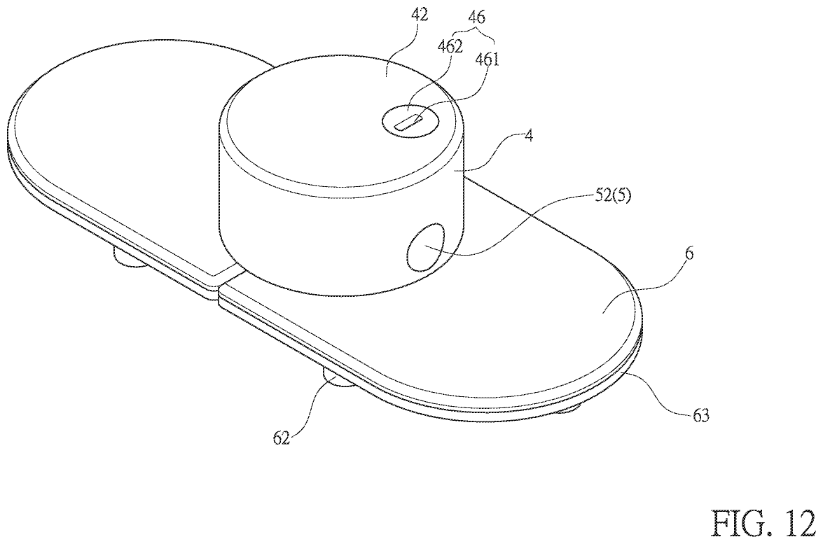

As shown in FIGS. 11 and 12, under such a condition, the shackle 5 of the present invention is enclosed and covered by the lock body 4 and is thus not exposed to the outside. By means of the material of high strength, the lock body 4 is sufficiently capable of resisting destruction caused by an external force. Further, when an external force is applied to powerfully strike or hit the rounded end portion 52 of the shackle 5, in addition to the material of the shackle 5 that exhibits a high strength to resist destruction induced by such an external force, the conic portion 521 of the rounded end portion 52 of the shackle 5 is set in abutting engagement with the expanded opening section 452 of the lock bore 45 so as to transmit such an external force through the expanded opening section 452 of the lock bore 45 to the lock body 4, not allowing the external force to transmit through the shackle 5 to the lock core 47 to expose the lock core 47 and the lock tongue 471 thereof to potential risks of being shocked or even damaged.

Further, when an evildoer uses an electrical drill to drill the lock core 47, since the lock core 47 is provided, on an outer side thereof, with the protective cover lid 46, the electric drill will first contact the protective cover lid 46 to be blocked thereby from contacting the lock core 47, so that the lock core 47 is protected from damage caused by drilling made with an electric drill. Further, the protective cover lid 46 itself is made of a material that exhibits a high strength, so that in addition to the strength thereof that is hard to be damaged through drilling, the diameter of the protective cover lid 46 is made slightly smaller than the hole diameter of the first accommodation zone 43, so that after the protective cover lid 46 is disposed into the first accommodation zone 43, the protective cover lid 46 is in fact in a condition of being not constrained by the first accommodation zone 43 in respect of rotating in situ. Thus, in case of being drilled by an electric drill, when the electric drill gets into contact with the protective cover lid 46 through drilling, the protective cover lid 46 will be caused to rotate in situ by following the rotation of the electric drill. In this way, the electric drill is prevented from conducting effective cutting and drilling. Further, the protective cover lid 46 and the lock core 47 are provided with the cushion ring 463 arranged therebetween, and the cushion ring 463 functions to reduce the contact area between the protective cover lid 46 and the lock core 47 so as to minimize the frictional force induced between the protective cover lid 46 and the lock core 47 thereby helping make the protective cover lid 46 rotating in situ when be drilled by an electric drill and thus making the electrical drill totally impotent for conducting cutting and drilling.

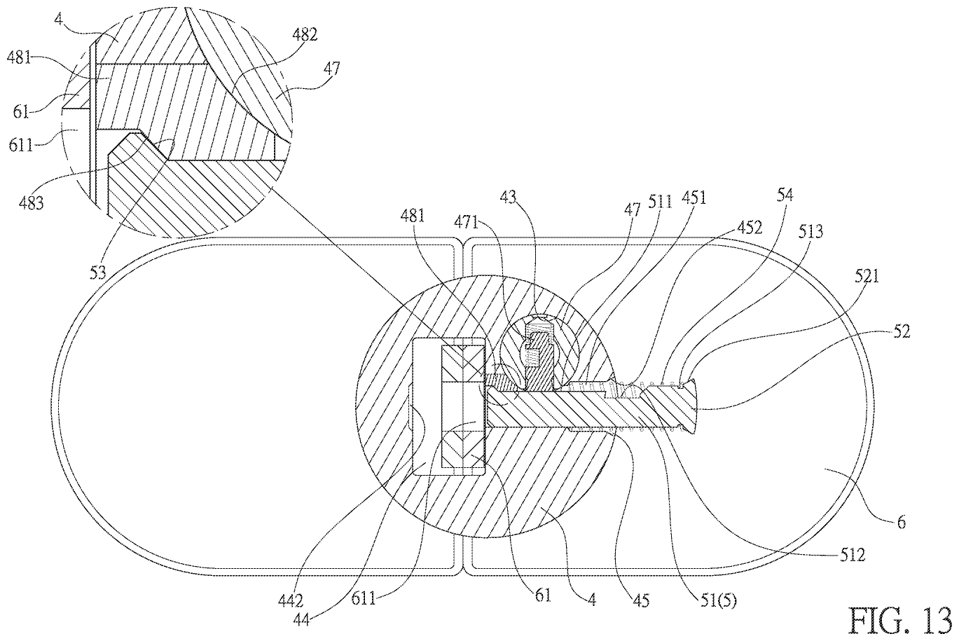

Following the above, to unlock, as shown in FIG. 13, an operator puts a key (not shown) through the penetration opening 461 of the protective cover lid 46 inside the top portion 42 of the lock body 4, and makes a slight rotation for adjusting the key to align with and extend into the keyhole 472 of the lock core 47, and then, the lock tongue 471 of the lock core 47 can be operated to rotate such that when the rotation of the lock tongue 471 reaches a position where it is allowed to get off the cut-off notch 512 of the shackle 5, the shackle 5 is no longer constrained by the lock tongue 471 and the spring force from the spring 54 encompassing the shackle 5 elastically drives the shackle 5 to move along the lock bore 45 to eject out of the lock body 4, until the hook portion 53 of the shackle 5 is stopped by the curved trough 483 of the inset portion 481 of the closure plate 48, whereby the shackle 5 is made completely retracted out of the holes 611 of the two lug 61, and the operation of unlocking is done. Afterwards, the operator may simply remove the lock body 4.

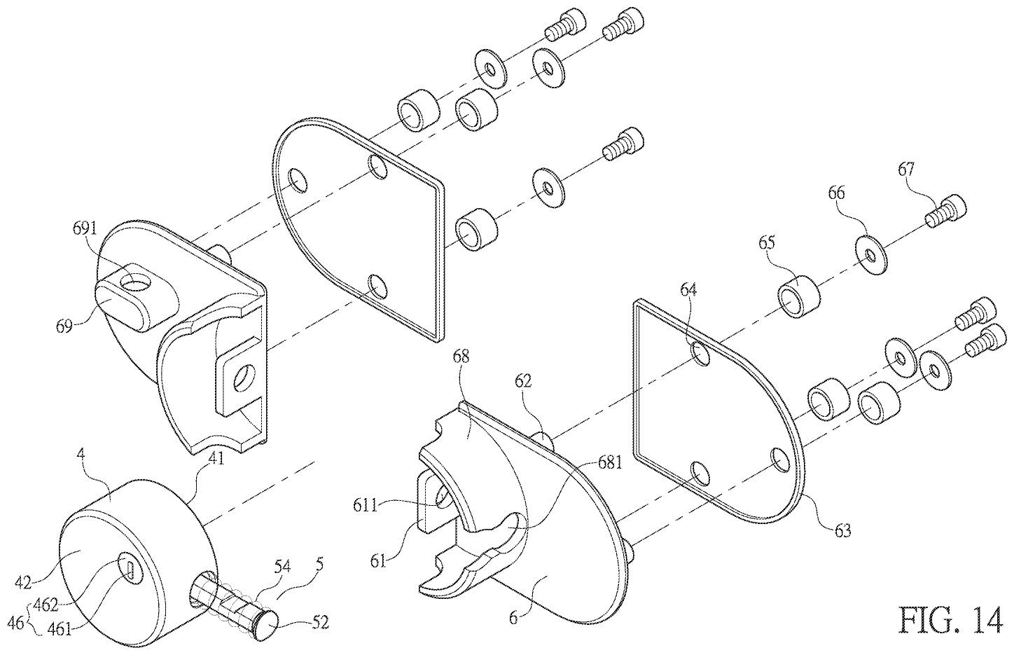

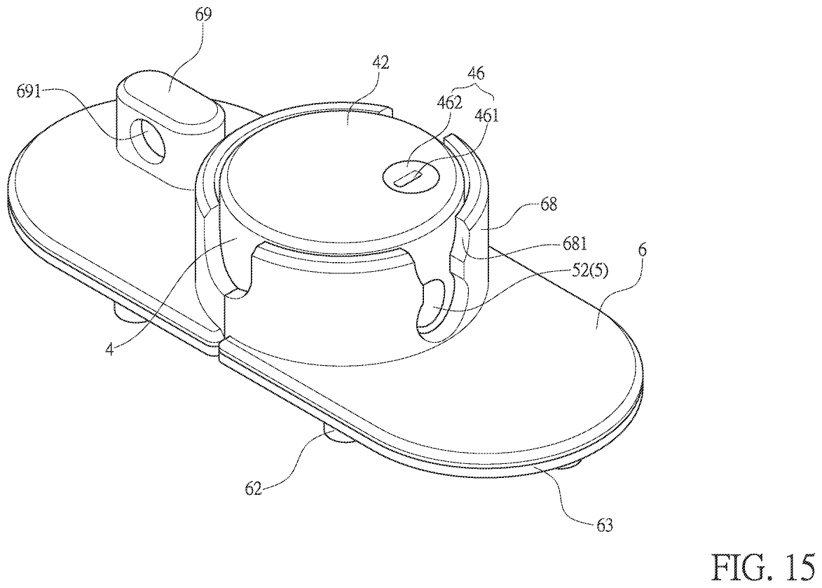

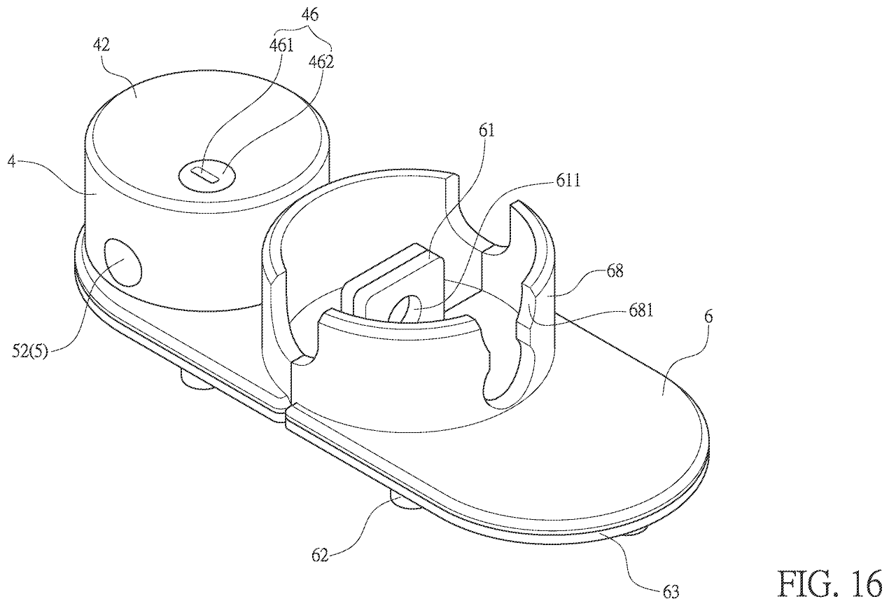

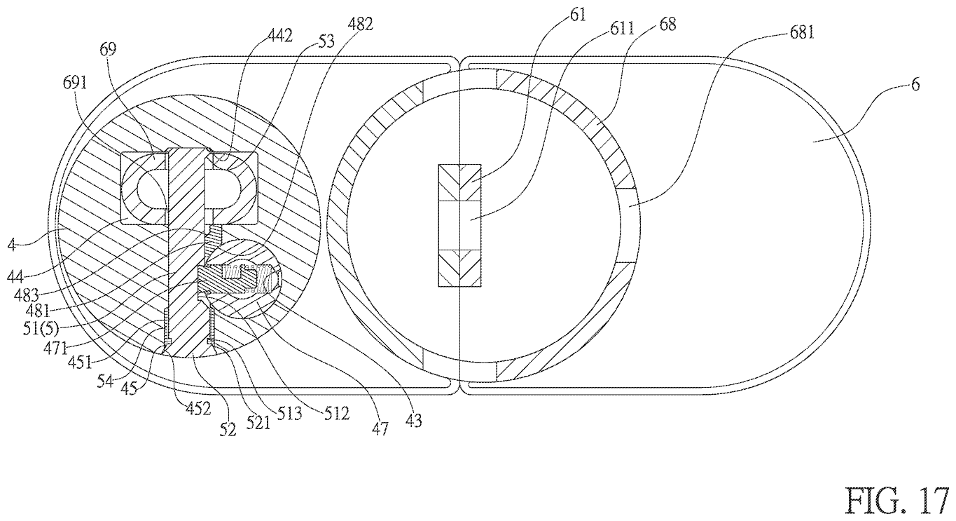

In another embodiment of the present invention, reference being had to FIGS. 14-17, raised walls 68 are circumferentially arranged around the lugs 61 of the two locking hasps 6. The raised walls 68 of the two locking hasps 6 define a space that is sufficient to accommodate the lock body 4 therein, so that the lock body 4 is surrounded and enclosed by the raised walls 68 to provide enhanced protection of the lock body 4 against hitting by external forces. Further, the raised walls 68 are formed with a plurality of notches 681 to enable fingers of the operator to extend through the notches 681 to grip and hold the lock body 4. Further, at least one of the notches 681 is set to correspond, in position, to the shackle 5, so that the shackle 5 may extend through the raised wall 68 by way of such one of the notches 681 to conduct operations of locking and unlocking in combination with the lock body 4.

Further, the locking hasps 6 may be provided, on a front side thereof, with at least one ancillary lug 69. The ancillary lug 69 is formed with a hole 691, and preferably, the ancillary lug 69 is arranged in a direction that is different from the lug 61 so as to be readily differed from the lug 61 for easy identification. To implement, when an operator unlocks and removes the lock body 4 from the lugs 61, the operator may then hang the lock body 4 on the ancillary lug 69 for temporary positioning, wherein the second accommodation zone 44 of the lock body 4 may receive the ancillary lug 69 to inset therein. In this way, the lock body 4 is provided with a location for temporary storage and keeping, and this helps eliminate the embarrassing situation where there is no place for storing or keeping the lock body 4 after unlocking. Further, the shackle 5 may be operated for locking and attaching to the hole 691 of the ancillary lug 69 so that the lock body 4 is securely attached to the ancillary lug 69, making the ancillary lug 69 temporarily held in a more secured manner.

The efficacy that the above-described structure of the present invention may provide is that in the present invention, the shackle 5 can be deeply hidden in the lock body 4 and is not readily damaged, wherein the lock core 47 is arranged in an upstanding manner in the lock body 4, and the keyhole 472 of the lock core 47 is arranged to face toward the top portion 42 of the lock body 4 to allow an operator to easily and efficiently find the keyhole 472 of the lock core 47 for conducting an unlocking operation, and further, the lock core 47 is protected by the protective cover lid 46 from being damaged. The present invention exhibits feature of both locking security and easiness of use. Further, since the lock core 47 is arranged in a vertically erected or upstanding manner in the lock body 4, the diameter of the lock body 4 can be reduced for fabrication and applications so as to achieve compactness and easiness of operation. Further, since the lock core 47 is arranged in a vertically erected or standing manner in the lock body 4, a slight increase of the height of the lock body 4 allows for an increase of the length of the lock core 47 disposed therein, so as to enable increase and sophistication of the tumblers arranged inside the lock core 47 to thereby further increase the difficulty of breaking the lock core 47, and this further enhances the locking security of the lock device.

I claim:

1. A lock device, at least comprising a lock body and a shackle, the lock body at least comprising:
a bottom portion, which is located on a bottom side of the lock body;
a top portion, which is located on a top side of the lock body and is formed with a hole;
a first accommodation zone, which is recessed from the bottom portion into interior of the lock body and is in communication with the hole of the top portion;
a second accommodation zone, which is formed through recessing inwardly of the bottom portion, the second accommodation zone including a communication section in communication with the first accommodation zone;
a lock bore, which extends perpendicularly from a lateral side of the lock body to reach into and communicate with the second accommodation zone, the lock bore being in communication with one side of the first accommodation zone;
a lock core, which has one end that is provided with a lock tongue and an opposite end that is formed with a keyhole, the lock core being received in the first accommodation zone, such that the end of the lock core that is formed with the keyhole faces in a direction toward the top portion of the lock body;
a closure plate, which is set on and closes the bottom portion of the lock body and has a surface from which an inset portion is extended to match with the communication section of the second accommodation zone; and
a shackle, which comprises a shackle body, which is insertable into the lock bore of the lock body.

2. The lock device according to claim 1, wherein the lock body is made of a heat-treated metallic material that exhibits a high strength.

3. The lock device according to claim 1, wherein the bottom of the lock body is formed with a recessed area that is recessed into the interior of the lock body, the first accommodation zone being formed as being recessed from the recessed area into the interior of the lock body.

4. The lock device according to claim 1, wherein the first accommodation zone has a hole diameter that is greater than a hole diameter of the hole of the top portion of the lock body.

5. The lock device according to claim 1, wherein the second accommodation zone has a sidewall in which a trough is formed.

6. The lock device according to claim 1, wherein the lock bore is in communication with one side of the first accommodation zone.

7. The lock device according to claim 1, wherein the lock bore is provided with a large-diameter section that has a relatively large hole diameter adjacent to an outer circumference of the lock body.

8. The lock device according to claim 7, wherein the large-diameter section of the lock bore is provided with an expanded opening section that is inclined so as to extend to and connect to the outer circumference of the lock body.

9. The lock device according to claim 1, wherein the lock bore corresponds, in position, to the trough formed in the sidewall of the second accommodation zone.

10. The lock device according to claim 1, wherein the lock tongue is extendible out of a lateral side surface of the lock core.

11. The lock device according to claim 1, wherein the end of the lock core that is provided with the lock tongue is further formed with a cut-off notch.

12. The lock device according to claim 3, wherein the closure plate is set in and closes the recessed area of the bottom portion of the lock body.

13. The lock device according to claim 12, wherein the closure plate has a thickness that corresponds to the recessed area of the bottom portion, so that the closure plate, in a condition of being set in and closing the recessed area of the lock body the bottom portion, forms a flat form with respect to the bottom portion of the lock body.

14. The lock device according to claim 1, wherein the closure plate comprises a top support portion that is protruded to match with the cut-off notch of the lock core.

15. The lock device according to claim 1, wherein the inset portion of the closure plate is provided, on a side surface thereof, with an arc-surface side that is in the form of an arc curved surface extending in an axial direction thereof.

16. The lock device according to claim 1, wherein the inset portion of the closure plate is provided, in an opposite side thereof, with a curved trough in the form of a circular arc configuration.

17. The lock device according to claim 1, wherein the shackle is made of a heat-treated metallic material that exhibits a high strength.

18. The lock device according to claim 1, wherein the shackle is sleeved with a spring.

19. The lock device according to claim 1, wherein the shackle body of the shackle is provided, on one side thereof, with a flat cut section that extends in an axial direction thereof and includes a surface in the form of a flat plate, and a notch is formed in the flat cut section.

20. The lock device according to claim 1, wherein the shackle body of the shackle is provided, on an end thereof, with a rounded end portion, and an opposite end of the shackle body is provided, on a lateral side thereof, with a hook portion.

21. The lock device according to claim 20, wherein a circumferential recessed groove is formed in connection between the shackle body and the rounded end portion.

22. The lock device according to claim 20, wherein the rounded end portion of the shackle has an inner surface that is formed as a conic portion converging inwardly, from a large size to a small size, for connection with the shackle body.

23. The lock device according to claim 1, further comprising a protective cover lid, wherein the protective cover lid is disposed in the first accommodation zone of the lock body and in abutting engagement with the lock core, the protective cover lid being formed with a penetration opening that penetrates through a main body thereof, the protective cover lid being formed, on one surface thereof, with a protrusion portion that has a relatively small diameter.

24. The lock device according to claim 23, wherein the protrusion portion of the protective cover lid has a diameter that is slightly smaller than the hole of the lock body the top portion.

25. The lock device according to claim 23, wherein the protrusion portion of the protective cover lid is not higher than a height of the bottom portion of the lock body.

26. The lock device according to claim 23, wherein a cushion ring is arranged between the protective cover lid and the lock core.

27. The lock device according to claim 23, wherein the protective cover lid is made of a heat-treated metallic material that exhibits a high strength.

28. A locking hasp for use with a lock device, the locking hasp being applied to an object to which the lock device is applied, the hasp having a front side having an end on which a lug is provided, the lug being formed with a hole through which a shackle of the lock device is extendible, the hasp having a back side that is provided with a plurality of threaded tubes each of which is provided, in an interior thereof, with a thread.

29. The locking hasp according to claim 28, wherein the locking hasp is fit to a pad, the pad being provided with a plurality of through apertures that respectively receive the threaded tubes of the hasp to extend therethrough.

30. The locking hasp according to claim 28, wherein the locking hasp comprises a raised wall that is circumferentially arranged around the lug, wherein two such locking hasps are arranged opposite to each other and the raised walls of the two locking hasps define a space therebetween for accommodating a lock body.

31. The locking hasp according to claim 30, wherein the raised wall is formed with a plurality of notches.

32. The locking hasp according to claim 31, wherein at least one of the notches corresponds, in position, to the shackle of the lock device.

33. The locking hasp according to claim 28, wherein the locking hasp is provided, on the front side thereof, with at least one ancillary lug.

34. The locking hasp according to claim 33, wherein the ancillary lug is formed with a hole.

35. The locking hasp according to claim 33, wherein the ancillary lug is arranged at a direction that is different from the lug.
